(19) United States
(12) Patent Application Publication
(10) Pub. No.: US 2007/0255833 A1
(43) Pub. Date: Nov. 1, 2007

(54) System and methods for managing resources in grid computing

(75) Inventors: Amit Sharma, Bangalore (IN); Keyur Gor, Ahmedabad (IN); Neel Arurkar, Bombay (IN)

Correspondence Address: NIXON PEABODY, LLP, 401 9TH STREET, NW, SUITE 900, WASHINGTON, DC, 20004-2128, US

(73) Assignee: Infosys Technologies, Ltd., Bangalore (IN)

(21) Appl. No.: 11/411,853

(22) Filed: Apr. 27, 2006

(51) Int. Cl. G06F 15/173

(52) U.S. Cl. 709/226

(57) ABSTRACT

A system, method, and computer program product for managing resources, including a server adapted for interacting with at least one control system to schedule multiple jobs using at least one resource is disclosed. The system further comprises an agent adapted for monitoring execution of the at least one resource and a database server adapted for storing at least one grid resource data. Furthermore, the system includes an interface adapted for submitting the multiple jobs to the at least one resource in addition with various meta-attributes. In one embodiment of the present technique, the system comprises a method for providing an integrated and service oriented architecture to the system. Furthermore, the system implements adaptation and manageability concepts and integrates scheduling capabilities.

### BACKGROUND OF THE INVENTION

1. Field of the Invention

The present technique relates generally to a grid computing system and a method of managing resources using applications and the infrastructure of the resources. More particular, the various embodiments in accordance to the present technique relates to an integrated and service oriented architecture of computing systems present technique.

### DISCUSSION OF THE BACKGROUND

The various embodiments according to the present technique allow effective management of resources and multiple grid jobs. Accordingly, the management of resources may be performed by various management capabilities and “Quality of service”(referred as QoS hereinafter) negotiations. The various embodiments focus on monitoring the grid computing system for system failures by interfacing with at least some embodiments of grid schedulers.

Grid computing may be defined as a mechanism for managing a heterogeneous set of computing elements, operating systems, policy decisions and environments. A long-term vision of enterprise grid computing community may be non-dedicated and interoperability of various disparate systems, wherein the various disparate systems being part of similar organization or various organizations. Grid computing may be looked upon by various experts as a technology, whereby the technology may potentially change the globe like the Internet.

However, various problems emerged out with the developments in the grid concepts. In accordance to solving these problems, substantial work may be being carried at various levels. For example, in the form of infrastructure management systems, job schedulers, and mechanisms for implementing security. Particularity, in one aspect, one class of infrastructure management system, comprises a solution, wherein the solution, combines multiple technical elements for solving business problems. In another aspect, with respect to the other class of the infrastructure management system, the other class emerged from different initiatives of universities located globally. In these situations, the primary concern, relating to evolutionary growth of the technology results in the complexity of the grid system. Accordingly, manageability and integration for the grid systems may be very essential.

Integration of manageability aspects of the architecture of grid systems may be very essential. There may be a number of commercial and non-commercial schedulers available, including Open PBS, Condor, LSF and Load Leveler. The schedulers perform the functions of matching a job's requirements with the available resources, scheduling the job on the resources, and overall management of the job execution lifecycle.

Typically, the requirements in enterprises require a system that may relate the business objectives of the end user to the infrastructure level details of the system. While the former talks only about grid management and allocation, the latter talks about management in data grids. By way of exemplary example, an academic institution may use such resources to perform better way of managing its infrastructure by using custom manageability feature. As alternate exemplary example, a corporate may require user friendly remote administration interface that allows job tracking and system monitoring from any web browser which may be another feature of the present technique. Likewise, a stock exchange may require high flexibility and modularity and shorter or combination thereof turnaround times without having to incur any additional expenditure on infrastructure. In accordance, the client applications may be needed for providing ability in responding to changes during operating conditions, taking self-corrective actions, when exceptions may be detected and limit the human intervention time required during the normal and abnormal operating conditions.

Accordingly, there may be a requirement for a system allowing a unified grid management architecture for computation and data grids managing complicated systems using intuitive and policy level management. Additionally, the system should provide the integrity for scheduling jobs with the above features. Furthermore, there may be also a requirement for effectively managing the grid infrastructure and also the grid jobs monitoring system failures from a central or remote workstation using an automated interface for reducing the cost apart from controlling the workflow in the grid computing systems.

### SUMMARY OF THE INVENTION

The present technique provides a system and method for managing resources integrating functions of scheduling control, autonomic capabilities and a multi level QOS repository.

In one aspect of the present technique, a system for managing resources is disclosed. The system includes a server adapted for interacting with at least one control system to schedule a plurality of jobs using at least one resource and an agent adapted for monitoring execution of the at least one resource. The system further includes a database server adapted for storing at least one grid resource data; and an interface adapted for submitting the plurality of jobs to the at least one resource in addition with a plurality of meta-attributes.

In another aspect of the present technique, a method for managing resources is disclosed. The method includes scheduling a plurality of jobs on at least one resource by interacting with at least one control system using at least one server and executing the plurality of jobs on the at least one resource for taking a plurality of self corrective actions required for adaptive behavior by monitoring with at least one agent. The method further includes storing a grid resource data on at least one database server and submitting the plurality of jobs to the at least one resource in addition with a meta-attribute using at least one interface.

### BRIEF DESCRIPTION OF THE DRAWINGS

These and other features, aspects, and advantages of the present technique will become better understood when the following detailed description may be read with reference to the accompanying drawings in which like characters represent like parts throughout the drawings, wherein:

FIG. 1 is a block diagram depicting a resource management system of a grid computing system for generating an approach for multi-level QoS management, in accordance with an embodiment of the present technique.

FIG. 2 is a block diagram depicting the logical architecture of the resource management system, in accordance with an aspect of the present technique.

FIG. 3 is a flow diagram illustrating the flow of steps involved in the process of submission and tracking the status and receiving the output of the jobs, in accordance to the present technique.

### DETAILED DESCRIPTION OF THE PREFERRED EMBODIMENTS

The following description is full and informative description of the best method and present technique presently contemplated for carrying out the present technique which may be known to the inventors at the time of filing the patent application. Of course, many modifications and adaptations will be apparent to those skilled in the relevant arts in view of the following description in view of the accompanying drawings and the appended claims. While the present technique and method described herein may be provided with a certain degree of specificity, the present technique may be implemented with either greater or lesser specificity, depending on the needs of the user. Further, some of the features of the present technique may be used to advantage without the corresponding use of other features described in the following paragraphs. As such, the description should be considered as merely illustrative of the principles of the present technique and not in limitation thereof, since the present technique may be defined solely by the claims.

As a preliminary matter, the definition of the term “or” for the purpose of the following discussion and the appended claims may be intended to be an inclusive “or”. That may be, the term “or” may be not intended to differentiate between two mutually exclusive alternatives. Rather, the term “or” when employed as a conjunction between two elements may be defined as including one element by itself, the other element itself, and combinations and permutations of the elements. For example, a discussion or recitation employing the terminology “A” or “B” includes: “A” by itself, “B” by itself and any combination thereof, such as “AB” and “BA.” It may be worth noting that the present discussion relates to exemplary embodiments, and the appended claims should not be limited to the embodiments discussed herein.

The present technique relates to a system and method for managing resources integrating functions of scheduling, autonomic capabilities and a multi level QoS repository.

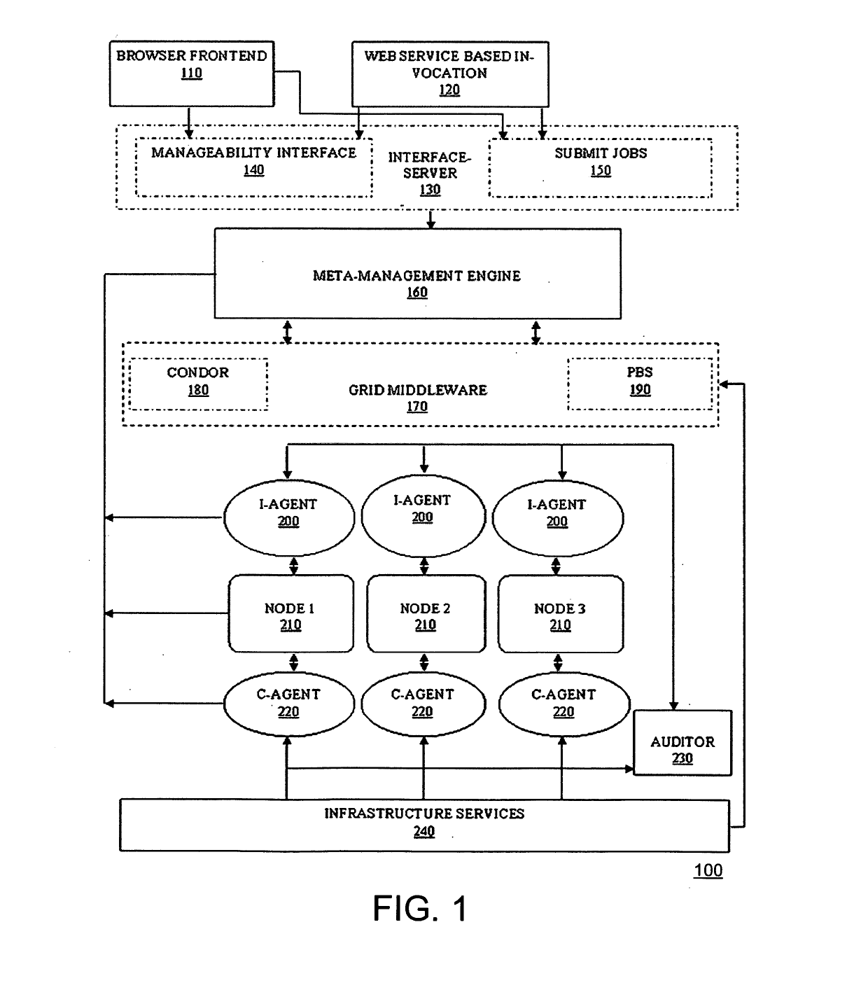

Referring now to figures, FIG. 1 illustrates a resource management system 100 for generating an approach for multi-level QoS management, in accordance with an embodiment of the present technique. The resource management system present technique 100 includes a browser front end module 110 and web service based invocation module 120. The browser front end module 110 provides a graphical user interface (referred as GUI hereinafter) front end for specifying job submission details. In one aspect of the present technique, multiple key use cases of the GUI comprise multiple keys enabling certification of authorizations. Multiple users may be provided with an authorization, whereby the multiple users may select from available list of applications. The first key “Login” may be adapted for enabling the user to type his identification and enter into the resource management system. The second key “Change Password” may be adapted for providing security with this unique functionality. The third key Submit Job data file may be in accordance may be adapted for submission of the jobs and includes the data files. The at least other embodiments the fourth key “Submit Job Data” source may be adapted for specifying the third party data source. Furthermore, the fifth key “View Status” may be adapted for providing the status of the submitted jobs for execution. The sixth key “View Report” may be adapted for providing the reports as per the requirement. Finally, the seventh key Configure may be adapted for providing configuration requirements.

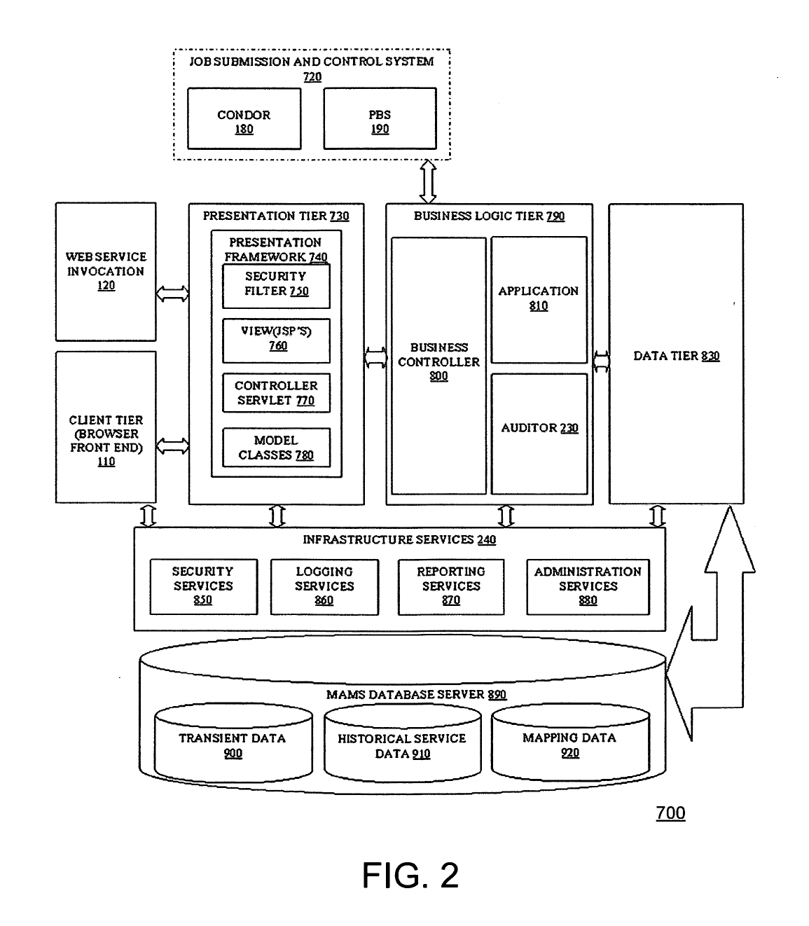

It should be noted that the browser front end module 110 may not involve in the process of creating job submission files. The browser front end module 110 may be linked with the interface tiers as will be explained in greater detail below in relationship to FIG. 2. The web service based invocation module 120 eases the process of job submissions. The invocation module 120 addresses manageability and complexity issues of the present system. The invocation module 120 may be linked with the interface tiers as explained below. The interface tier includes an interface server 130 comprising two tiers namely, manageability interface tier 140 and submit jobs tier 150.

The interface server 130 carries out the creation of the job submission file. Accordingly, the interface server 130 stages the executable files from multiple users or the third party users. The interface server 130 with the support of the manageability interface 140 enable a provision of specifying composite meta-attributes while submitting the job. It should be noted the meta-attributes may be required information resulting in better understanding about the resources during job submissions. Furthermore, the submit jobs tier 150 involves with the details and submission of jobs with browser module 110 and the web service module 120. The submit jobs tier 150 specifies each user and submit one or more submissions. Accordingly, each submission may be scheduled as one or more jobs. Furthermore, each job may be executed on one or more resources. It should also be noted that, each resource may have only one owner. A resource may be one or more machines whereby multiple jobs may be executed on various machines.

The resource management system 100 further includes a meta-management engine 160. The meta-management engine 160 includes a set of main functions, the details of which will be explained in subsequent sections to follow. The engine 160 may be linked with the interface server 130 directly as indicated in FIG. 1. The engine 160 allows multiple users to submit a job through the manageability interface module 140 and submit jobs tier 150. With the aid of the interface module 140 and submit jobs tier 150, the meta-management engine 160 provides the ability to specify policies. A policy may be a set of instructions involved in the process level management of the resource management system.

The engine 160 also provides a view of the status of submitted jobs. Secondly, it carries out pre-scheduling and filtering logic for each job based on the historical service data. Furthermore, the engine 160 submits the job to the Job submission and control system (referred as JSCS hereinafter) as will be explained in greater detail with reference to FIG. 2.

In one embodiment of the present technique, the engine 160 implements the scheduling control functionality by interacting with the JSCS. Furthermore, the engine 160 monitors each node for job execution state and perform exception related functions based on contracts between user and resource owner. Thirdly, the engine 160 queries the Meta Attribute Management Server (referred as MAMS hereinafter), explained below with reference to FIG. 2, to obtain transient data and historical data and inputs both the data into the MAMS database server with the help of the auditor 230 that may be explained in detail below. Fourthly, the engine 160 allows the web service invocations 120 on auditor 230 using the interface server 130. Finally, the engine 160 allows using JSCS in the process and provides a generic interface implemented for the JSCS.

The system 100 further includes a grid middleware tier 170. In certain aspect of the present technique, the grid middleware tier 170 provides the user relationships among the jobs using the interface server 130. It may be linked with the engine 160 and comprises of at least one of a Condor 180 and a PBS 190. The condor 180 and the PBS 190 may be the two JSCS interacting with the submit jobs tier 150 via the meta-management engine 160 and configured to report resource availability on the nodes. The system 100 works with the grid middleware, acting as the lower level schedulers for it, and enhancing the scheduling capabilities thereof. Further, the present technique integrates factors affecting scheduling into user friendly meta-attributes. Furthermore, the users may submit jobs using a Graphical User Interface (referred as GUI hereinafter). It should be noted that though reference is made of using the GUI, as will be appreciated by those skilled in the art, other user interfaces known in the art may also be used with certain embodiments of the present technique.

In addition to this, the grid middleware tier 170 provides users complicated conditional relationships among the various jobs including QOS support, including but not limited to resource availability, trust levels. This tier 170 further supports infrastructure level support for making queries to multitudes of the MAMS database. In another embodiment, the interface server 130 interacts with the multiple users or the third party users for scheduling the jobs on the grid resources. Accordingly, adaptive behavior may be required and an auditor 230 monitors the execution of the job on each resource and interacts with the present system and the JSCS. Adaptive behavior is the ability to respond to changes in operating conditions and taking self-corrective actions in case of exceptions and further limiting the amount of human intervention required for normal as well as abnormal operating conditions. In accordance, the MAMS database server stores grid resource data, wherein the MAMS database server constantly updates with the auditor 230. The MAMS database server may be used by the interface server 130. Furthermore, in these cases, each submission may be meant for scheduling various jobs. Accordingly, each job may be meant for executing on one resource. Under these situations, an important factor may be meant for connecting only with one resource owner.

In another embodiment of the present technique, the resource management system 100 includes multiple infrastructure agents (referred as i-agents hereinafter) 200, multiple nodes 210 and multiple contract agents (referred as c-agents hereinafter) 220. The contract agents provide the ability to take control actions on the grid nodes based on contracts defined between the multiple users and the machine owners. Furthermore, the system 100 may take automatic actions without requiring user intervention for all kinds of conditions which arise in the system 100. I-agents 200 keep noticing of the resource availability periodically. These agents 200 may be not aware of the contractual obligations (mutual agreement) of the nodes 210. Accordingly, i-agents 200 result in reporting about the resource availability to the condor 180 and PBS 190. The nodes 210 fulfill the contractual obligations for example, the resources that the nodes 210 agree to provide to the resource management system 100. By way of an example, a single node may agree to provide a physical memory M over a certain period of time t and in a condition that if any of the nodes 210 fail to provide as per the agreement a reporting mechanism may be provide to inform about the failure. The c-agents 220 may be located at each node 210. Further, the c-agents 220 verify whether the nodes 210 fulfill the contractual obligations. These agents 220 keep on monitoring the nodes 210.

In yet another embodiment of the present technique, the auditor 230 may be linked with i-agents 200, nodes 210 and the c-agents 220 directly in a manner that the agents 200 and 220 keep informing the auditor about the nodes execution status. The auditor 230 may be a metering and monitoring system having exception handlers for each type of exception generated ,wherein the exception may occur on account of the nodes on the system not meeting contractual obligations. Accordingly, the auditor basically serves two purposes. Firstly, the auditor 230 updates the transient data of the MAMS database. Secondly, the auditor 230 takes required control action, depending on the type and severity of the violation. By way of an exemplary example, during check pointing the job on the resource, the available memory may be lower than a threshold in anticipation of a node failure. An infrastructure services tier 240 enhances modularity, flexibility and extensibility. Modularity is achieved by dividing the system 100 into chunks or modules of equal size. Flexibility is achieved by modifying the system 100 in accordance to the usage of the other modules. Furthermore, extensibility is achieved by extending the capabilities for the multiple users when using the system 100. The infrastructure service tier 240 further provides a logical separation resulting in better re-use of the components at various other tiers. The infrastructure service tier 240 may be integrated with the other tiers for providing an interface with the JSCS. This will be explained in greater detail below.

Referring now to figures, FIG. 2 illustrates the logical architecture 700 of the resource management system, in accordance with certain aspect of the present technique. As explained earlier, the architecture 700 includes a job submission and control system (referred as JSCS hereinafter) module 720 The JSCS 720 may be a system under which a various number of resources for executing multiple jobs may be placed. The client tier (browser front end 110) functions as a tier designed for avoiding client side component distribution and maintenance overheads. The client tier also performs client side validations for faster User Interface (referred as UI hereinafter) responses. Accordingly, the client tier comprises multiple first set of software components required for presenting the UI to the multiple users.

The architecture 700 further includes a presentation tier 730 which may separate presentation logic from the business logic. The tier 730 also maintains an easily configurable screen flow, comprising multiple second set of software components for generation of the user interface, wherein the user interface may be used by the resource owner. The presentation tier 730 further comprises program codes in relationship to screen flow, navigation and presentation logic. The presentation tier 730 further comprises a presentation framework 740 that architects the parts namely a security filter 750, wherein the data maintained by the i-agents 200 and c-agents 220 should not be modifiable by the owner of the resource. The presentation tier 730 comprises multiple fifth set of software components for building the presentation framework 740.

The presentation tier 730, further acts as a filter for verifying the correct information to pass in and filters out the unnecessary information. As illustrated in FIG.2, the framework 740 includes View Java Servlet Program's (referred as JSP's hereinafter) 760, security filter 750, controller servlet 770 and model classes 780. The JSP's 760 that may be based on the architecture of the Model View Controller (MVC-2) pattern. The MVC-2 patterns with a set of Java Servlet program codes results in viewing the related objects. The security filter 750 includes a set of conditions and compares all incoming information with the set of conditions available. Furthermore, necessary actions may be performed when at least one of the conditions matches with the incoming information. The controller servlet 770 decouples data representation, application behavior and presentation and manages the interactions between the view objects and the model classes 780 that may be dependent on these objects. The model classes 780 may be helpful in centralizing the processing of a application 810 requests.

The architecture 700 further includes, a business logic tier 790 adapted for carrying out pre-scheduling and filtering logic for each job depending on historical data and transient data. In addition to this, the business logic tier 790 submits the job to the JSCS 720 and implements the scheduling control functionality by interfacing with the JSCS 720. Furthermore, the business logic tier 790 monitors each node for job execution state and performs exception related functions based on the contracts between the submitting user and the resource owner.

The business logic tier 790 further comprises a business controller 800 interacting with the application 810 and the auditor 230. The application 810, comprises a set of packages which includes a set of computer program codes relating to the pre-scheduling and filtering of each job based on the historical service data 910 from the history data table. Furthermore, the business logic tier 790 submits the job to the JSCS 720 and also implements the scheduling functionality by interacting with the JSCS 720. The business logic tier 790 gives greater support in monitoring each node for job execution state. It should be noted that, the business logic tier 790 performs exception relating functions that may be based on contracts from the submitting user to the owner of the resource.

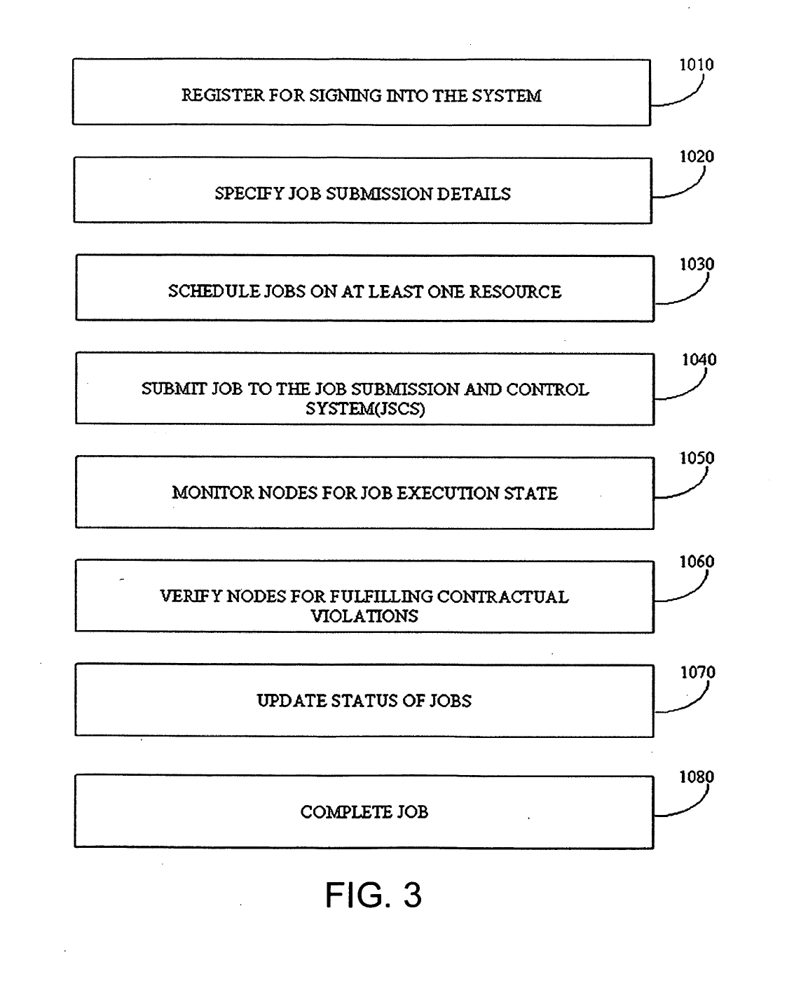

As illustrated in FIG. 3, the architecture 700 includes a data tier 830. The data tier 830 may have the ability to cache data comprising a multiple fourth set of components including a persistence logic adapted for interacting with the underlying data stores in the present technique. The data stores may be the various physical representations of the one or more data explained earlier.

The architecture 700 further includes the infrastructure tier 240. The infrastructure tier 240 further includes a security services 850, logging services 860, reporting services 870 and administration services 880. The security services 850 provide services of filtering and enabling only the non-specific applications to pass through and the relevant data sent to the next set of tiers that may be described below. Furthermore, the logging services 860 may be based on Log4j, a logging functionality service. The infrastructure tier 240 comprises an abstraction over the actual implementation used so that a different implementation of the logging functionality may be used in future. Accordingly, in these situations, the logging infrastructure tier 860 requires logging to be implemented without changing the application code.

In other embodiment, the reporting services 870 depend on the concept of Easy Hibernate Cache, or Apache JCS, or OS cache or the combination of these thereof as known. Accordingly, the infrastructure tier 240 comprises another abstraction over the actual implementation used so that a different implementation of the caching functionality could be used in future under such situations that require caching to be implemented without changing the application code. The reporting services 870 provides the reporting mechanism to the JSCS with the available resources and the administration services 880 provides the administration details whenever the system may be required. An integration tier integrates all the other tiers and interacts with the control system JSCS 720 frequently. The integration tier enables session management solutions holding data in memory for one set of sessions and in the MAMS database server 890 for the other set of sessions.

The architecture 700 further includes a meta attribute management server (referred as MAMS hereinafter) 890. The MAMS may be a database server comprising three kinds of data tables, namely, a transient data table 900, a historical service data table 910 and a mapping data table 920. The transient data table 900 reflects all the contractual violations encountered recently, and refreshes after a certain interval of time. The historical service table 910 comprises all the history of nodes of the MAMS database server 890. The historical data table 910 may be updated from the transient table 900 periodically, averaging many of the parameters stored thereof. A third type of data in the database server 890 may be the mapping data table 920 gives the user the choice of not supplying the data, where the data needs to be processed. The data to be processed may be taken from its own storage, or from a third party thereof. Furthermore, the mapping data table 920 contains the mapping relationship details whereby the data may be stored.

FIG. 3 depicts flow diagram illustrating the method involved in the process of submission and tracking the status and receiving the output of the jobs in accordance to the present technique. As illustrated, the method starts in step 1010, wherein multiple users register for signing into the resource management system. A sign-up link on the main page directs to a sign-up page. In the sign-up page, the resource owner has to provide his first-name, last-name, a user-name and a password. Additionally, the resource owner has to provide his e-mail address, wherein the e-mail address will be used to send all job-completion mails. A confirmation of registration has to be provided to the resource management system after filling the details related to user registration. The method continues in step 1020, wherein the job submission details may be provided. For this, a link may be provided for uploading pages in relationship with the jobs. In one embodiment of the present technique, the job file and the execution file may be specified in accordance to the resource management system.. Relevantly, the parameters in accordance to the job execution file may be specified.

The method continues in step 1030, wherein multiple resources may be scheduled. The availability of resources may be detected measuring the Central Processor Unit (referred as CPU hereinafter) execution cycles on each node of the resources. Furthermore, the jobs may be scheduled in accordance to the percentage of the CPU to the resources of the resource management system. At step 1040, the job is submitted to the JSCS. The jobs may be staged in accordance to the CPU percentage and submitted to the JSCS along with the meta-attributes.

The method continues at step 1050, wherein the nodes for job executions state is monitored. The i-agents and the c-agents as explained earlier sections above, may monitor contractual conditions based on QoS for taking respective action in such situations. The i-agents and the c-agents may be responsible to verify, whereby the node fulfill the contractual condition. By way of an exemplary example, a node may promise certain amount of physical memory over a certain period of time and the c-agents monitor each resource verifying whether the node may be meeting the contractual conditions. In addition to this, there may be a reporting mechanism, whereby the auditor may be informed by i-agents about the availability of resources.

At step 1070, the status of the jobs may be updated. The historical data and the transient data of the MAMS database server may be updated periodically based on the parameters stored thereof. The periodical updating of the data results in updating the nodal status, whereby the nodal status may be watched by the c-agents. The i-agents keep informing about the resource availability but may not be aware of the contractual conditions of the node. The method concludes at step 1080, wherein the jobs get completed. Furthermore, the pages and links may provide the completed jobs, current running jobs and the queued jobs thereof.

As will be appreciated by those skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that may be, in parallel. Furthermore, the functions may be implemented in a variety of programming languages. Such code, as will be appreciated by those skilled in the art, may be stored ot adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions may be electronically captured via optical scanning of the paper ot other medium, then compiled, interpreted or otherwise processed in a suitable manner if necessary, and then stored in a computer memory.

The sequence of instructions as explained in the method steps may include but not limited to, program code adapted for presenting the logical architecture, comprising program code adapted for configuring a first plurality of components required for presentation of the at least one interface to a plurality of users on at least one client tier. The sequence of instructions further includes program code adapted for configuring a second plurality of components required for generation of the at least one interface on at least one presentation tier. In addition to this the sequence of instructions may include program code adapted for configuring a third plurality of components for at least one business logic of the system on at least one business logic tier and program code adapted for configuring a fourth plurality of components for interacting with at least one data store on at least one persistence tier. In one embodiment of the present technique, the sequence of instructions may include program code adapted for providing at least one service for modularity, extensibility and flexibility or combination thereof on at least one infrastructure tier and program code adapted for supporting in interaction with the at least one control system on at least one sixth tier. In another embodiment of the present technique, the sequence of instructions may include program code adapted for storing at least one value on at least one data table of the at least one server to run on the at least one resource. In yet another embodiment of the present technique, the sequence of instructions may include program code adapted for storing at least one software program component required by the at least one interface.

As will be appreciated by a person skilled in the art, the present technique provides a number of advantages. In one embodiment, of the present technique, a method is provided for relating an integrated approach towards resource management through virtualization, dynamic and higher level policy management and autonomic capabilities collectively known as Business Service Monitoring (BSM). The system works with the grid middleware, acting as the lower level schedulers for it, and enhancing the scheduling capabilities thereof. Further, the present technique integrates factors affecting scheduling into user friendly meta-attributes. The system provides multiple users, a simple environment for submitting jobs, and tracking them.

In another embodiment, in accordance to the present technique, may be a full fledged meta-management system for the grid systems for better performance is disclosed. The present approach integrates the functions of scheduling and selecting control, autonomic capabilities, and a multi-level QoS repository. Multi-level QoS repository may be the centerpiece of the holistic architecture. This repository may store QoS-related data of the various services or resources at various levels of a conceptual hierarchy. Therefore, there may be data relating parameters current Q-length at a processor, average load value at a resource and a composite Reputation Rating of different online book selling services. An important characteristic of this repository may be that may be makes the QoS related history of the service or resource persistent. Before making a selection of scheduling decision, therefore, a user may take into account all this historical data.

In yet another embodiment of the present technique, the autonomic capabilities obviate to a certain extent the need for manual intervention in case of unexpected system failure conditions, and environmental changes. Accordingly, multi-level QoS management, autonomic capabilities allow the monitoring of contractual conditions based on QoS, and action to be taken in violated conditions. Furthermore, the multi-level QoS repository may be enabled to store data relating to QoS of one or more services and various resources at multiple levels of the conceptual hierarchy.

In accordance with certain implementations of the present technique, the method of scheduling may be synchronized with the QoS repository in the system depending on the decisions based on historical and transient data enabling multiple users to specify one or more constructs. Accordingly, the scheduling problems for grids systems may be analogous to the Service Selection problem for web services. Furthermore, the matching between user requirements and resource and service properties may be at the heart of both grid scheduling and service selection. By synching scheduling with the QoS repository in our architecture, such decisions may be allowed based on historical as well as transient data about the service. Correspondingly, syncing scheduling allow the user to specify constructs such as—“Schedule the job at a resource with the minimum Q-length”, or “Select a Service with a composite Reputation Rating greater than 80% or combination thereof. In addition to this, the autonomic capabilities enhance the capability for allowing the monitoring conditions based on the contractual obligations. Furthermore, the autonomic capabilities may be based on QoS repository.

While, the following description may be presented to enable a person of ordinary skill in the art to make and use the present technique and may be provided in the context of the requirement for a obtaining a patent. The description may be the best presently-contemplated method for carrying out the present technique. Various modifications to the preferred embodiment will be readily apparent to those skilled in the art and the generic principles of the present technique may be applied to other embodiments, and some features of the present technique may be used without the corresponding use of other features. Accordingly, the present technique may be not intended to be limited to the embodiment shown but may be to be accorded the widest cope consistent with the principles and features described herein. Firstly, with respect to encryption, all local data on the resources, files may be encrypted with appropriate encryption algorithms. Secondly, the data comprising passwords may be encrypted. Thirdly, all the input data from the user may be validated before they may be sent for usage. Fourthly, with respect to scalability, all the applications may be scalable both vertically and horizontally. In this aspect the architecture may be designed to be multi-tired so that various tiers may be individually clustered with load balancing depending on their scalable requirements. Fifthly, with respect to the availability of resources, to provide the required high availability, the architecture and the infrastructure may be designed to avoid single-points-of-failure at all tiers. In this aspect, all the components at the different tiers may be designed to be cluster-able to handle failures. Sixthly, with respect to manageability and extensibility, most of the key functionality of the present technique may be driven by parameters that can be specified in an external configuration file to make the application easily manageable. Finally, the architecture divides the present technique into multiple tiers thereinafter enhancing modularity, service-oriented and interface driven extensibility and making easier to take advantage of new technologies, relating to each tier individually without affecting the rest of the present technique.

Many modifications of the present technique will be apparent to those skilled in the arts to which the present technique applies. Further, it may be desirable to use some of the features of the present technique without the corresponding use of other features.

Accordingly, the foregoing description of the present technique should be considered as merely illustrative of the principles of the present technique and not in limitation thereof.

What is claimed is:

1. A system for managing resources comprising:
a server adapted for interacting with at least one control system to schedule a plurality of jobs using at least one resource;
an agent adapted for monitoring execution of the at least one resource;
a database server adapted for storing at least one data of the at least one resource; and
an interface adapted for submitting the plurality of jobs to the at least one resource in addition to a plurality of meta-attributes.

2. The system according to claim 1, further comprising an auditor configured for managing a plurality of exceptions using a plurality of handlers occuring on at least one node of the system not meeting a contract.

3. The system according to claim 1, further comprising at least one job submission module submitted by a plurality of users for policy based scheduling of the plurality of jobs for execution of the at least one resource, wherein the at least one resource is connected with the plurality of users.

4. The system according to claim 3, further comprising a plurality of keys for certification of authorizations , wherein the certification of authorizations includes the plurality of users and wherein the plurality of users may be authorized to use from at least one application.

5. The system according to claim 1, further comprising an integration tier for holding a plurality of sessions in the database server and in a memory.

6. The present technique according to claim 5, wherein at least one infrastructure tier further comprising:
at least one security service adapted for filtering to enable the at least one application;
at least one logging service adapted for providing an abstraction over an implementation for enabling a logging functionality;
at least one reporting service adapted for providing an abstraction over an implementation for enabling a caching functionality; and
at least one administration service adapted for providing the at least one data related to administration of the system.

7. The system according to claim 1, further comprising a plurality of tiers adapted for providing at least one logical architecture of the system further comprising:
at least one client tier adapted for a first plurality of components required for presentation of the interface to the plurality of users;
at least one presentation tier adapted for a second plurality of components required for generation of the interface;
at least one business logic tier adapted for a third plurality of components for at least one business logic of the system;
at least one persistence tier adapted for a fourth plurality of components for interacting with at least one data store;
at least one infrastructure tier adapted for providing a plurality of services, wherein the plurality of services include at least one of modularity or extensibility or flexibility or combination thereof; and
at least one integration tier adapted for supporting interaction with the at least one control system.

8. A method for managing resources comprising:
scheduling a plurality of jobs on at least one resource by interacting with at least one control system using at least one server;
executing the plurality of jobs on the at least one resource by taking a plurality of self corrective actions required for adaptive behavior by monitoring at least one agent;
storing a grid resource data on at least one database; and
submitting the plurality of jobs to the at least one resource in addition with a meta-attribute using at least one interface.

9. The method according to claim 8, further comprising interacting with the at least one agent using at least one auditor.

10. The method according to claim 9, further comprising interacting with the at least one control system based on a plurality of conditions to respond to at least one change or to take at least one action for at least one detected exception or to limit intervention of a plurality of users using the at least one auditor.

11. The method according to claim 8, further comprising updating at least one data on the at least one database server, wherein the at least one database server periodically provides the at least one data to the at least one resource.

12. The method according to claim 11, further comprising requesting the at least one data from the at least one database server and sending the at least one data to the plurality of users.

13. The method according to claim 8, further comprising tracking status of the plurality of jobs submitted using the at least one interface.

14. The method according to claim 8, further comprising creating the plurality of jobs by at least one job submission file resulting to submission of the plurality of jobs to the at least one resource.

15. The method according to claim 14, further comprising receiving and staging the plurality of jobs by the at least one resource.

16. The method according to claim 15, further comprising selecting at least one node after submitting the plurality of jobs to the at least one resource.

17. A computer program product tangibly embodying a plurality of instructions for managing resources, comprising:
program code adapted for scheduling a plurality of jobs on at least one resource by interacting with at least one control system using at least one server;
program code adapted for executing the at least one resource by monitoring with at least one agent;
program code adapted for storing at least one grid resource data on at least one database server; and
program code adapted for submitting the plurality of jobs in addition with a plurality of meta-attributes using at least one interface.

18. The computer program product according to claim 17, further comprising program code adapted for storing at least one software program component required by the at least one interface.

20. The computer program product according to claim 17, further comprising program code adapted for storing at least one value on at least one data table of the at least one server to run on the at least one resource.

21. The computer program product according to claim 17, further comprising program code adapted for storing at least one software program component required by the at least one interface.
